(19) United States
(12) Patent Application Publication
(10) Pub. No.: US 2007/0008080 A1
(43) Pub. Date: Jan. 11, 2007

(54) Combination electrical mosquito repeller and lamp assembly

(76) Inventor: Jen-Yen Yen, Yenpu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/175,209

(22) Filed: Jul. 7, 2005

(51) Int. Cl. G08B 3/10

(52) U.S. Cl. 340/384.2

(57) ABSTRACT

A combination electrical mosquito repeller and lamp assembly is disclosed to include a hand-driven dynamo for turning by hand to generate AC power supply for charging a storage battery when rectified into DC power supply and stabilized, a lamp circuit for producing light for illumination, a mosquito repeller circuit for generating a high frequency sound to repel mosquitoes, and a selector switch for selectively connecting DC power supply to the mosquito repeller circuit or the lamp circuit.

### BACKGROUND OF THE INVENTION

1. Field of the Invention

The present invention relates to an electrical mosquito repeller and more particularly, to a combination electrical mosquito repeller and lamp assembly.

2. Description of the Related Art

Conventionally, electrical mosquito evaporizer or electrical mosquito repeller may be used to expel mosquitoes. An electrical mosquito evaporizer is to heat a chemical fluid into vapor, letting the strong smell of the vapor repel mosquitoes. An electrical mosquito repeller is to generate a high frequency sound (about 10000 Hz) to repel mosquitoes. These conventional mosquito-repelling apparatus commonly use a dry battery to provide the necessary working voltage. When battery power is low, the apparatus becomes unable to work. Further, these conventional electrical mosquito-repelling apparatus cannot provide light for illumination.

### SUMMARY OF THE INVENTION

The present invention has been accomplished under the circumstances in view. It is the main object of the present invention to provide a combination electrical mosquito repeller and lamp assembly, which uses a hand-driven dynamo to generate power supply for working instead of the use of a dry battery. It is another object of the present invention to provide a combination electrical mosquito repeller and lamp assembly, which is convenient to carry by the user for use anywhere outdoors. It is still another object of the present invention to provide a combination electrical mosquito repeller and lamp assembly, which can be used as an electrical mosquito repeller as well as an illuminator.

To achieve these and other objects of the present invention, the combination electrical mosquito repeller and lamp assembly comprises a hand-driven dynamo for turning by hand to generate AC power supply, a rectifier circuit adapted to rectify AC power supply from the hand-driven dynamo into DC power supply, a voltage-stabilizer circuit adapted to stabilize output voltage of DC power supply from the rectifier circuit for charging a storage battery, a lamp circuit for producing light for illumination, a mosquito repeller circuit for generating a high frequency sound to repel mosquitoes, and a selector switch for selectively connecting DC power supply from the storage battery to the mosquito repeller circuit or the lamp circuit.

### BRIEF DESCRIPTION OF THE DRAWINGS

FIG. 1 is a circuit diagram of a combination electrical mosquito repeller and lamp assembly according to the present invention.

FIG. 2 is a system block diagram of the combination electrical mosquito repeller and lamp assembly according to the present invention.

### DETAILED DESCRIPTION OF THE PREFERRED EMBODIMENT

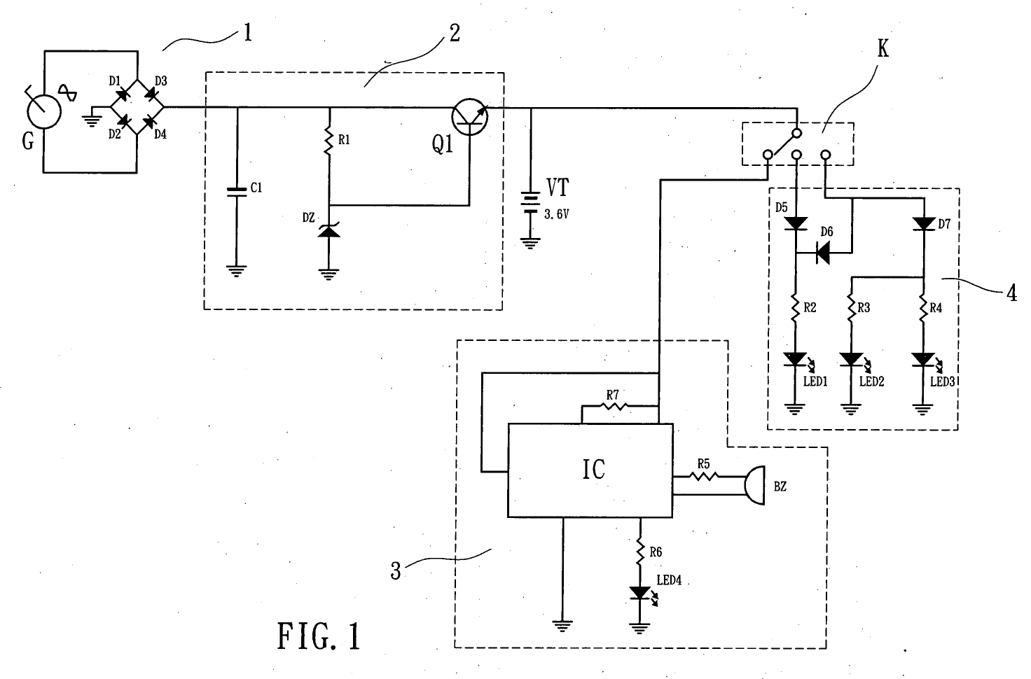

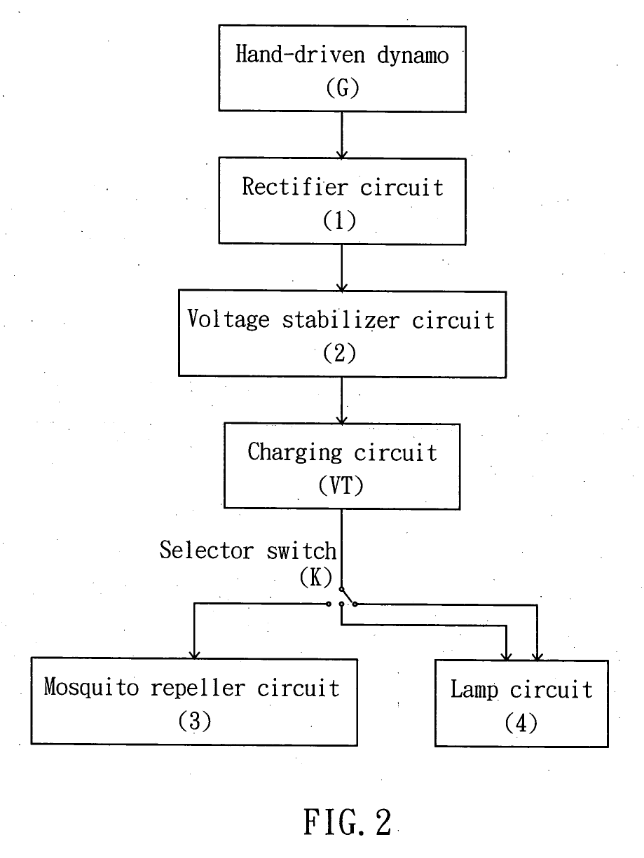

Referring to FIGS. 1 and 2, a combination electrical mosquito repeller and lamp assembly in accordance with the present invention is shown comprising a hand-driven dynamo G, a rectifier circuit 1, a voltage stabilizer circuit 2, a charging circuit VT, a selector switch K, a mosquito repeller circuit 3, and a lamp circuit 4.

The hand-driven dynamo G is rotatable by hand to generate AC power supply.

The rectifier circuit 1 is comprised of diodes D1˜D4, and adapted to rectify AC power supply received from the hand-driven dynamo G into DC power supply.

The voltage stabilizer circuit 2 is comprised of a capacitor C1, a resistor R1, a zener diode DZ, and a transistor Q1, and adapted to stabilize DC power supply received from the rectifier circuit 1 and to provide voltage-stabilized DC power supply to the charging circuit VT.

The charging circuit VT has a storage battery connected thereto, and is adapted to charge the storage battery with voltage-stabilized DC power supply received from the voltage-stabilizer circuit 2 and to provide storage DC power supply to the mosquito repeller circuit 3 and the lamp circuit 4.

The selector switch K is a single-blade multi-throw switch adapted to control selection of output DC power supply from the storage battery of the charging circuit VT to the mosquito repeller circuit 3 to repel mosquitoes, or to the lamp circuit 4 to give off light for illumination.

The mosquito repeller circuit 3 is comprised of a high-frequency sound generator IC, a buzzer BZ, resistors R6 and R7, and an indicator light LED4. The high-frequency sound generator IC is adapted to generate a high frequency sound for output through the buzzer BZ to repel mosquitoes.

The lamp circuit 4 is comprised of a plurality of high-brightness light emitting diodes LED1˜LED3, diodes D5˜D7, and resistors R2˜R4, and adapted to produce light for illumination when electrically connected.

The combination electrical mosquito repeller and lamp assembly is made in the form of a hand torch for convenient use. When operating the selector switch K to switch on the mosquito repeller circuit 3, DC power supply is transmitted from the storage battery of the charging circuit VT to the mosquito repeller circuit 3, thereby causing the high-frequency sound generator IC to generate a high frequency sound about 10000 Hz for output through the buzzer BZ to repel mosquitoes, and at the same time the indicator light LED4 is turned on to give a visual indication. Because human beings cannot hear 10000 Hz high frequency sound, this high frequency sound does no hurt to the ears. When operating the selector switch K to switch on the lamp circuit 4, the selector switch K can be connected to a first contact to switch on one single light emitting diode LED1 or a second contact to switch on three light emitting diodes LED1˜LED3 as desired.

As indicated above, the user can rotate the hand-driven dynamo G to generate AC power supply, for enabling generated AC power supply to be rectified into DC power supply by the rectifier circuit 1 and then stabilized by the voltage-stabilizer circuit 2 for charging the storage battery of the charging circuit VT to the saturated status.

Further, the capacitor C1 of the voltage-stabilizer circuit 2 is to remove noises; the zener diode DZ and transistor Q1 of the voltage-stabilizer circuit 2 is to control stabilization of voltage; the transistor Q1 is set to be electrically connected with 3.6V, preventing damage of an improper voltage to the storage battery of the charging circuit.

As indicated above, the invention provides a combination electrical mosquito repeller and lamp assembly, which has the following advantages:

1. The hand-driven dynamo G can be rotated by hand to generate power supply for charging the storage battery of the charging circuit VT, eliminating the use of a dry battery.

2. The combination electrical mosquito repeller and lamp assembly is compact and convenient for carrying by the user for use in any place outdoors.

3. The combination electrical mosquito repeller and lamp assembly is safety in use because 3.6V output voltage is not harmful to the body of a human being.

4. The combination electrical mosquito repeller and lamp assembly can be used as an electrical mosquito repeller as well as an illuminator.

5. The voltage-stabilizer circuit 2 stabilizes output voltage to the storage battery of the charging circuit VT, prolonging the working life of the storage battery.

A prototype of combination electrical mosquito repeller and lamp assembly has been constructed with the features of FIGS. 1 and 2. The combination electrical mosquito repeller and lamp assembly functions smoothly to provide all the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A combination electrical mosquito repeller and lamp assembly comprising:
a hand-driven dynamo rotatable by hand to generate AC power supply;
a rectifier circuit adapted to receive AC power supply from said hand-driven dynamo and to rectify received AC power supply into DC power supply, said rectifier circuit being comprised of four diodes;
a voltage stabilizer circuit adapted to receive DC power supply from said rectifier circuit and to stabilize received DC power supply;
a charging circuit, said charging circuit having a storage battery and being adapted to receive stabilized DC power supply from said voltage stabilizer circuit and to charge the storage battery thereof with received DC power supply;
a mosquito repeller circuit electrically connected to said charging circuit and adapted to generate a high frequency sound to repel mosquitoes, said mosquito repeller circuit being comprised of a high-frequency sound generator, a buzzer, a plurality of resistors, and an indicator light;
a lamp circuit electrically connected to said charging circuit and adapted to give off light for illumination, said lamp circuit being comprised of a plurality of high-brightness light emitting diodes, a plurality of diodes, and a plurality of resistors; and
a selector switch adapted to selectively electrically connect said mosquito repeller circuit and said lamp circuit to said charging circuit.

2. The combination electrical mosquito repeller and lamp assembly as claimed in claim 1, wherein said voltage-stabilizer circuit is comprised of a capacitor, a resistor, a zener diode and a transistor, said transistor being set to let a predetermined voltage level pass through said voltage-stabilizer circuit.
